(19) United States
(12) Patent Application Publication
(10) Pub. No.: US 2021/0309377 A1
(43) Pub. Date: Oct. 7, 2021

(54) ENERGY ABSORBING DEVICE ADAPTED FOR A MILD IMPACT OF AN AIRCRAFT, UAV, EQUIPPED WITH A PARACHUTE

(71) Applicant: Pavlos GIANNAKOPOULOS, Patra (GR)

(72) Inventor: Pavlos GIANNAKOPOULOS, Patra (GR)

(21) Appl. No.: 17/228,270

(22) Filed: Apr. 12, 2021

Related U.S. Application Data
(63) Continuation of application No. PCT/GR2019/000068, filed on Oct. 10, 2019.

(30) Foreign Application Priority Data
Nov. 2, 2018 (GR) 20180100506

(51) Int. Cl. B64D 17/36

(52) U.S. Cl. CPC B64D 17/36

(57) ABSTRACT

An energy absorbing device provided at the parachute riser strap of an aircraft, UAV, etc., adapted to reduce the otherwise high forces resulting from the weight of the aircraft, the speed of descent and, ultimately, the speed of impact, activated by the pilot or by means of the photoelectric cell attached underneath the aircraft measuring the distance from the ground.

### THE FIELD OF THE ART

The invention relates to the field of the art of whole-aircraft, UAV, etc., parachutes and it proposes an energy absorbing device which enables the absorption of a sufficient amount of the energy exerted on a parachute as a result of the abruptly acting force thereupon during landing, thereby minimizing the otherwise adverse effects resulting from the excessive forces being exerted upon impact on the ground.

### THE BACKGROUND OF THE INVENTION

It is known that the majority of the injuries and in some cases deaths of passengers of aircraft equipped with a whole-aircraft parachute are associated to a large extent with the impact on the ground, during which the force developing as a result of the impact is high and it is further increased as the weight of the aircraft and the weight of any cargo that it transports increases. In the prior art, despite the significant improvement in the design of parachutes for emergency equipment, the injuries of aircraft passengers are still a problem today.

Especially in aircraft equipped with a whole-aircraft parachute, the excessive speed of descent has been identified and confirmed as a key factor for the injuries of passengers upon impact on the ground. Injuries during the impact of an aircraft equipped with a whole-aircraft parachute are often caused by high speed, both horizontally and vertically, at the time of impact on the ground.

The object of the invention includes all manned aircraft of civil and military aviation, as well as unmanned aircraft (UAV), flying targets, airborne cargo on wooden pallets dropped off by means of parachutes, the parachutists, the Space Command Module, etc., in which cases the existing parachute technology can offer effective protection for the deceleration of descent of aircraft, etc., as all these are subject to high forces resulting from impact on the ground with everything this entails.

Nevertheless, the design of the parachute needs to fulfil the safety requirements of the crew for an emergency landing on land or water, in order to absorb the high forces exerted abruptly upon impact.

During the impact of aircraft equipped with whole-aircraft parachutes on hard surfaces, considerable forces may be transferred to the crew via the surfaces of the aircraft, such as the floor and the seats. If these forces are not absorbed at satisfactory levels, they can lead to serious injuries or even deaths of passengers. Simple manufacture of aircraft seats is not sufficient to protect the passengers seated in them from the abrupt force exerted thereupon during impact on land or water. Aircraft equipped with whole-aircraft parachutes do no need to be designed so as to hit the ground at a rate of descent of 25 ft/sec.

In fact, the resulting touchdown impact is further increased mainly because aircraft carry heavy loads. This additional weight leads to the aircraft descending at a higher speed and hitting the ground with a significantly increased force, thereby rendering passengers more prone to injuries. The round canopy of the parachute used by aircraft equipped with a whole-aircraft parachute has been in use for many years with major changes, and elaborate efforts have been undertaken in recent years to reduce problems related to the speed of impact for both the passengers and the loads the aircraft is carrying.

It is thus an object of the invention to address the aforementioned problem of the prior art by proposing the supply of the whole-aircraft parachute with an energy absorption device, which can achieve the reduction of the otherwise high force of the weight of the aircraft and the load it carries, and the reduction of the speed of descent and eventually of landing of the parachute and the aircraft. It is an object of the invention to propose the aforementioned energy absorbing device for the main riser strap of the whole-aircraft parachute, and the aforementioned energy absorbing device comprises a strap of predetermined length, wherein at least a portion of the strap is folded to half its original length, and the two resulting half lengths of the strap are being sewed with a plurality of lengthwise or transverse stitches, wherein one end of the folded and transversely sewed strap portion is connected at the first coupling member to a carabiner at the end of the main riser strap of the parachute and the other end is connected at a second coupling member to a carabiner at the meeting point of the harness straps of the aircraft to lift said aircraft, wherein the activation of said energy absorbing device at a given time during the approach of the aircraft to the ground at an altitude of 7-8 m leads to tearing of said plurality of transverse stitches provided in the folded and sewed portion of the strap, such tearing resulting in the exertion of a force counterbalancing the force of the weight of the aircraft, thereby decelerating the fall and ultimate speed of the impact of the aircraft onto the ground.

The use of folded straps as energy absorption devices has been disclosed in Greek Patent GR-1003447 and European Patent EP-1069008, wherein such devices are being applied in the safety belts of automobiles with a scope of providing protection against the forces abruptly exerted by the safety belts on the occupants fastened to the seat belts of the vehicle due to their inertia that tends to move them forwardly in the event of a collision, such forces exerted by the safety belts resulting in an instantaneous stroke of high pressure, which these energy absorbing devices come to absorb to a certain extent.

A disadvantage associated with the use of such energy absorbing devices of the prior art applied in the safety belts of automobiles is the excessive extension of the seat belt strap during activation of the device, that is due to the fact that, as the transverse stitches of the double-folded S-shaped strap portion of the safety belt are being torn, the length of the device doubles and the safety belt restraining the shoulder of the occupant of the vehicle extends to a correspondingly increased length. This essentially renders the safety belt partially inefficient due to the excessive extension thereof that allows an excessive forward movement of the body of the occupant, thereby resulting in a potential injury. If the length of the energy absorbing device is reduced in order to address this disadvantage, through reduction of the extension of the belt, the energy absorption capacity of the device is respectively reduced.

It is thus a further object of the present invention to propose the implementation of the proposed energy absorbing device adapted to absorb the energy being applied to the main strap of a whole-aircraft parachute prior to its impact on the ground, wherein a full energy absorbing capacity is provided without the undesirable extension in the length of the strap of such energy absorbing device, which retains the same original length after tearing of the transverse stitches provided therein.

It is therefore a principal object of the present invention to provide an energy absorbing device suitable for advantageous adaptation onto the main parachute riser strap due to the herein afforded short extension in the length of the energy absorbing device following activation thereof prior to the impact of the aircraft on the ground, as the length of the strap of the device remains the same before and after activation thereof and a smooth, linear energy absorption and lower operating space is required due to the linear tearing of the transverse stitches provided along the folded and sewed strap portion of the device.

It is a further object of the present invention to provide the proposed energy absorption device advantageously adapted onto a riser strap of the parachute with the aforementioned first coupling member thereof attached to the main parachute riser strap, and said energy absorbing device is equipped with a release system that initiates operation thereof at an appropriately selected instant during the approach of the aircraft to the ground.

Furthermore, the use of folded straps as energy absorbing devices for parachutists has become known through the Greek Patent Application Number 20140100569, and U.S. patent application Ser. No. 14/756,969, equipped with a release and activation system known as rapid release 3 ring system for parachutes.

It is a further object of the invention to provide a combination of the proposed energy absorbing device appropriate for advantageous adaptation onto the main riser strap of the parachute with a release system that initiates operation thereof, such release system being the known rapidly operating 3-ring release system, which is conventionally used for the cutting off of the main parachute in case of failure of operation thereof in order to initiate deployment of a reserve parachute in an emergency situation, wherein the aforementioned 3-ring release system is used in combination with the energy absorbing device of the invention appropriately oriented with small and middle ring thereof fixedly connected to the folded strap portion of the device and with the third large ring connected to the aforementioned first coupling member so as to follow the movement of the latter upon activation of the energy absorbing device.

Another related object of the invention is to provide the proposed energy absorbing device and rapidly operating 3-ring release system thereof with an appropriate means of unlocking the 3-ring release system and activating of the device, by way of example with a retaining pin, wherein mechanical activation of the device in case of emergency is initiated by the pilot, who visually observes approaching of the ground and mechanically unlocks such retaining pin thereby causing the activation of the energy absorbing device mounted onto the main riser strap of the parachute when a selected predetermined altitude of a few meters from the ground is reached so as to provide an energy absorption effect and a reduction of the forces developing upon impact on the ground. Another object of the invention, aimed at overcoming situations where approach to the ground is performed under the cover of darkness or on other occasions when intended activation of the proposed energy absorbing device by the pilot is not feasible, or in the case of UAVs, etc., is to propose the equipping of the device with an altimetric photocell capable of infrared detection of ground proximity attached underneath the aircraft, which either emits a sound signal to alert the pilot of the need to activate the proposed energy absorbing device at a specific moment prior to the aircraft crashing onto the ground when a certain predetermined height and distance from the ground of approximately 7-8 m is reached, or it automatically performs the electromechanical unlocking and activation of the energy absorbing device integrated in all manned civilian or military aircraft, as well as UAVs and flying target aerial vehicles, and airborne cargo on wooden pallets dropped off by means of parachutes.

The retaining pin of the handle is removed before flight thereby unlocking said handle for the activation of the rapidly unlocked 3 ring release system and said handle is connected to the wire rope of the bowden cable which functions as a device with one end thereof connected to the handle thereby providing the pulling force required at the other end thereof for the removal of the retaining pin of the 3 ring release system. The bowden cable comprises a helicoidally twisted outer housing of concentric configuration made of wire and plastic and encases the inner wire made of stainless steel or galvanized steel, or another suitable material. The basic mechanical manufacture of such cables consists of a set of multiple twisted wires and is employed in different combinations for the manufacture of a different version with other cables. More specifically, the present invention concerns a remote system of transmission of force/pull resulting from the abruptly exerted force during the pull.

It should herein be noted that the closer to the ground the energy absorbing device is activated, the more drastic the reduction in the speed of the parachute is achieved, reaching a rate of 5 ft/sec with an impact on the aircraft. Thereafter, the speed begins to increase however the aircraft will have already landed, thereby hitting the ground at a rate of descent of 5-6 ft/sec.

A further object of the invention is to provide the aforementioned energy absorbing device advantageously fitted onto the riser strap of a parachute with specifications comprising design parameters including the overall length of the device, which determines the effective length of linear displacement of an arm thereof adapted to move along the strap and tear the transverse stitches provided therein, the plurality of transverse stitches along the folded length of the strap and the strength of the thread used in sewing these transverse stitches, wherein the aforementioned design parameters are being determined depending on the nominal value of the energy that the devices are required to absorb in each particular case in combination with the weight of the aircraft including the weight of the load it is carrying.

### BRIEF DESCRIPTION OF THE DRAWINGS

With reference to the accompanying drawings we will hereinafter describe illustrative preferred embodiments of the invention.

FIG. 1 shows a perspective view of the energy absorption device according to a first preferred embodiment of the invention prior to activation thereof, wherein the strap of the energy absorption device is presented.

FIG. 2 shows a perspective view of the energy absorption device according to a first preferred embodiment of the invention, wherein the strap of the energy absorption device is presented in a longitudinally deployed layout prior to activation thereof.

FIG. 3 shows a perspective view of the energy absorbing device, following activation thereof, according to a preferred embodiment of the invention wherein the strap of the device is presented in a longitudinally deployed layout.

FIG. 4 shows a perspective view of the first coupling member with a 3 ring release extension system.

FIG. 5 shows a perspective view of the first coupling member.

FIG. 6 shows a perspective view of the second coupling member.

FIG. 7 shows a perspective view of the energy absorption device prior to activation thereof, according to a second preferred embodiment of the invention.

FIG. 8 shows a perspective view of the energy absorption device following activation thereof, according to a second preferred embodiment of the invention.

FIG. 9 shows a perspective view of the aircraft cockpit with the pilot in readiness during descent thereof with a deployed parachute being provided with the energy absorbing device of the invention located at a suitable point at the end of the main riser strap of the parachute.

FIG. 10 presents the aircraft illustrated in FIG. 9 during as it descends with the energy absorbing device of the invention, wherein the folded strap of the device is presented prior to activation thereof.

FIG. 11 presents the aircraft illustrated in FIG. 10 with the energy absorbing device of the invention, wherein the strap of the device is presented following activation thereof.

FIG. 12,13,14 show a perspective view of the energy absorbing device prior to activation thereof, positioned at an appropriate point at the end of the main riser strap of the parachute attached to a UAV, target, crate.

FIG. 15 presents the altimetric photocell which employs infrared detection of ground.

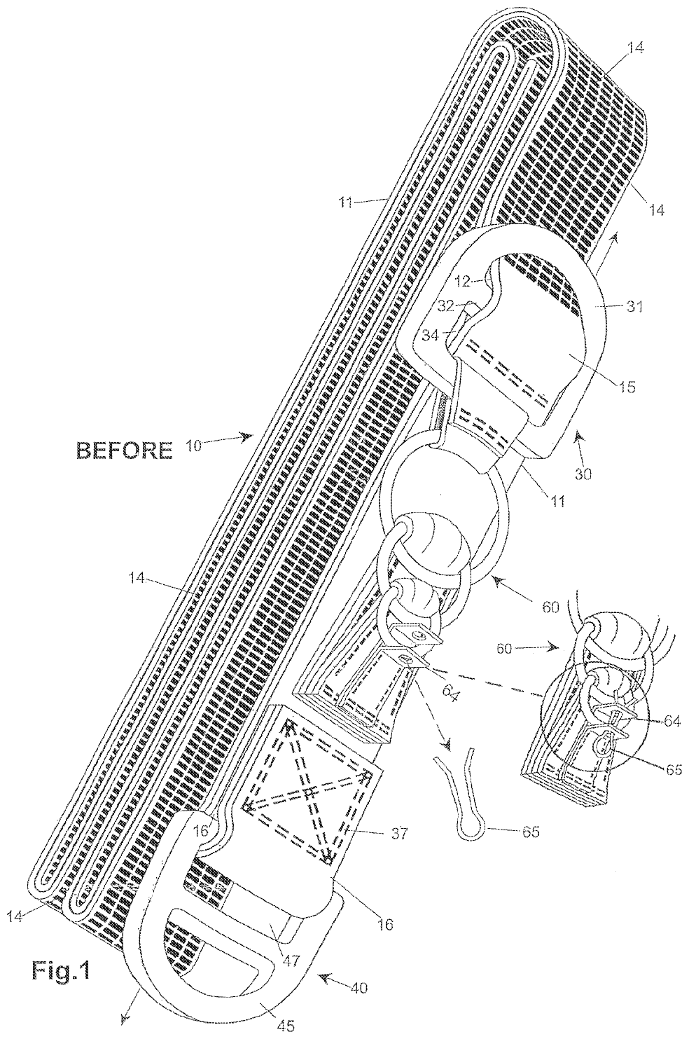

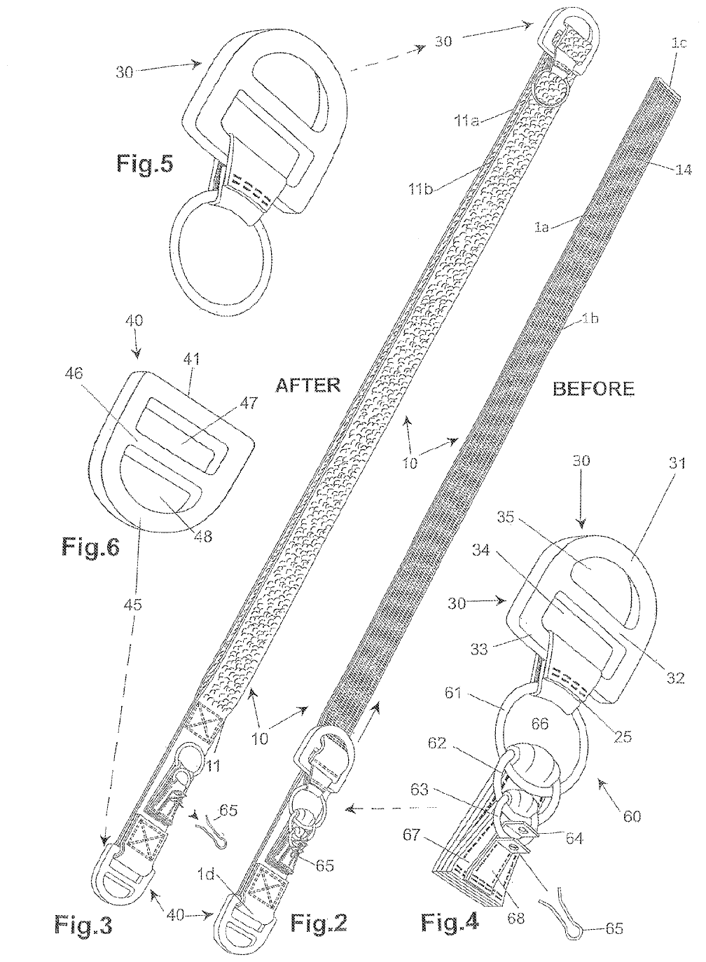

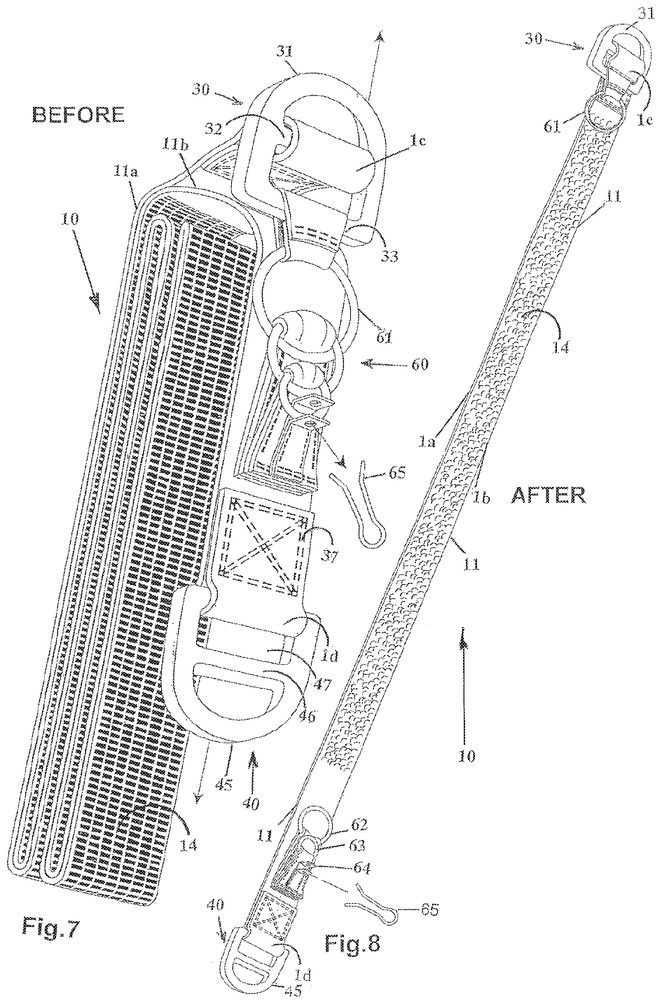

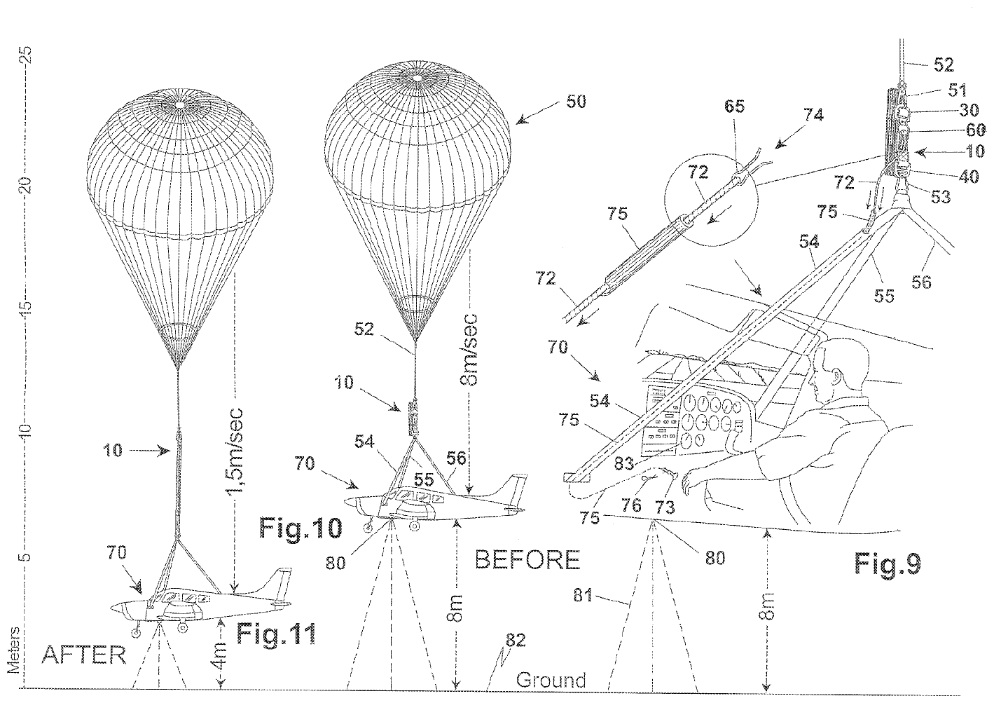

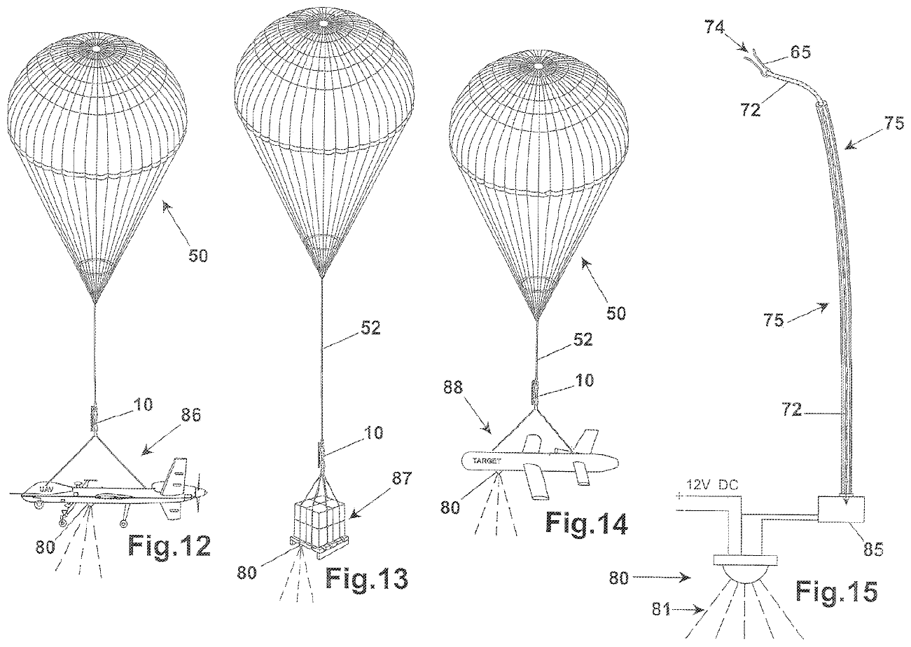

### DETAILED DESCRIPTION OF PREFERRED EMBODIMENTS

With reference to the accompanying drawings we will hereinafter describe illustrative preferred embodiments of the invention. As a finalized end product, the energy absorbing device (10) of the invention, as shown in FIGS. (1),(2),(3),(7),(8), is connected with the first coupling member (30) thereof, FIG. (4), at the carabiner (51), FIG. (9), at the end of the main riser strap (52) of the parachute (50), and the other end thereof is connected with the second coupling member (40) at the carabiner (53), FIGS. (1),(6),(9), at the ends of the corresponding main straps (54,55,56) of the harness of the aircraft (70) for the elevation thereof.

The energy absorbing devices (10) of the invention, FIGS. (1),(2),(3),(7),(8), comprise a strap (11) of a predetermined length, which is defined by a pair of parallel, longer sides (1a, 1b) of equal length which are vertically oriented during operation of the device, and by a pair of parallel shorter sides (1c,1d) of equal length, which are horizontally oriented during operation of the device. In correspondence with the above definition, the length of the device (10) is defined to mean the length of the sides (1a) and (1b), and the width of the device is defined to mean the length of the sides (1c) and (1d). A selected portion of the strap (11) is folded into half the original length thereof and the two resulting halves (11 a, 1 1 b) of the strap are being sewed with a plurality of transverse stitches (14). One end of the strap (11) is connected with a first coupling member (30) to the carabiner (51) provided at the end of the main riser strap (52) of the parachute (50), whilst the other end of the strap (11) is connected with a second coupling member (40) to the correspondingly oriented carabiner (53) provided at the end of the corresponding main riser straps (54, 55, 56) of the aircraft (70), FIG. (9).

The above-mentioned first coupling member (30), FIG. (4), is a strong plate with generally rectangular shape at one end thereof with a width corresponding to the width of the strap (1 1), said coupling member comprising the arm (33) at one end thereof to which the 3-ring release system (60) is connected, and the other end thereof forming a suspension D-ring (31) connected to the above-mentioned end carabiner (51) provided at the end of the main riser strap (52) of the parachute (50). It also comprises an additional transverse arm (32) which extends parallel to the arm (33) approximately to the middle of the plate (30), wherein the strap (11) is either strongly connected to the upper transverse arm (32) or passes around it. As shown in FIG. (4), an opening (34) is formed between the arm (33) and the arm (32) and another opening (35) is formed between the arm (32) and the upper surface of the suspension ring (31).

The other aforementioned second coupling member (40) is sheet metal forming a ring (45) with a linear arm (41) at the other end thereof, FIG. (6).

It also comprises a transverse arm (46) which extends parallel to arm (41) approximately at the middle of the sheet metal (40) with an opening (47) forming between the arm (41) and the arm (46), and an opening (48) created between the arm (46) and the suspension D-ring (45).

The lower end of strap (11) is connected to the coupling member (40) with its edge (d) passing through the opening (47) and thereafter being folded to create a loop opening (16), which encloses the linear arm (41) of the coupling member, thereafter the end of the edge (1d) of the strap abutting and securely sewed along line (17) of strap (11) with a sewing thread (37). Thus, the linear arm (41) is trapped within the above-mentioned loop (16) of the strap, whereby the coupling member (40) can no longer be extracted therefrom obstructed by the transversely extending linear arm (41), which extends across the width of the strap (11) that surrounds it, FIGS. (1,2,6).

According to a preferred embodiment of the invention, the element used for holding the energy absorbing device (10) under tension and for initiating activation thereof when needed is a 3-ring release system (60), which, as shown in FIGS. (1,4,7), consists of three serially engaged rings, i.e. a small ring (63), a middle ring (62), and a large bottom ring (61). A similar such 3-ring release system (60) is known as a worldwide used parachute component by sport parachutists and military parachutists to connect each of the two riser straps of the parachute with the straps bearing the parachutist. Said 3-ring release system is advantageous as compared to other release methods in that it allows a parachutist to quickly cut away the main parachute with just one move in case of malfunction, in preparation for the deployment of a reserve parachute.

The large bottom ring (61) of the 3-ring release system (60) used in the present invention, FIGS. (1,4,7), is surrounded by a strap strip or piece of fabric (25) which encloses and traps the ring (61) on the one hand and the lower arm (33) of the above-mentioned first coupling member (30) on the other hand. In this way, the ring (61) is arranged to follow the movement of the first coupling member (30) if and when it is being disconnected from the remaining assembly of the other two rings (62), (63), which are mutually engaged and wherein the middle ring (62) is securely bound with a strap strip (66) onto the strap (11) and the small ring (63) is securely bound with a strap strip (67) onto the strap (11). Finally, a small strap strip is attached, which creates a loop (64) enclosing the small ring (63), such strap strip being locked with a retaining pin (65), FIG. (4), which passes through the same. With this arrangement the small ring (63) can easily be released from the retaining loop (64) when a slight pulling action is exerted on the retaining pin (65), such pulling action causing the immediate collapse of the mutually engaged rings (62, 63), the release of the large bottom ring (61) and the activation of the first coupling member (30) that is fixedly bound to it via the aforementioned arm (33), FIGS. (1, 3, 4, 8). The upward motion of the coupling member (30), following its release from the 3-ring retaining and release system (60), is subject to the pulling force exerted by the riser strap (52) of the parachute (50) and results in the activation of the energy absorbing device (10) of the invention and the tearing of the stitches (14) through which the strap portions (11a, 11 b) of the selected portion of the strap (11) that is being folded in two halves of the original length are bound together, thereby a counter-force to the weight of the aircraft (70) and to the weight of the equipment it carries being exerted, such counter-force effecting smoothening of its descent and landing on the ground, as the fall and the eventual speed of impact of the aircraft (70) on the ground is reduced and the otherwise encountered adverse effects of the impact are minimized.

According to a first embodiment of the invention as shown in FIGS. (1), (2), the above-mentioned selected portion of the strap (11) which is folded longitudinally in half its original length thereby creating two adjacent half strap portions (1 1a, 11 b) is the total of the length of the strap, which extends from one end (1 c) to the other end (1d) of the strap (11).

As shown in FIGS. (1, 2) the strap (1 1), after the fastening of its end (1d) onto the second coupling member (40), passes through the opening (34) of the coupling member (30) and at this point the two portions (11 a, 1 1 b) of the strap are separated to form an opening (12), which surrounds the transverse arm (32) of the coupling member (30), thereafter being stapled with a plurality of transverse stitches (14) along its residual length, which according to a preferred embodiment of the invention is being wound in a roll. In this case, when a force exceeding a predetermined value is applied onto the movable coupling member (30) and the 3-ring release system (60) is unlocked, arm (32) carries out the tearing of the predefined transverse stitches (14) and separates the two abutting sewed portions (11 a) and (1 1b) of the strap from a point (15) located downstream the 3-ring release system (60) up to the end of the strap, thereby ensuring the absorption of the energy exhibited as a result of the abruptly acting force that is exerted by the end of the main riser strap (52) of the parachute (50) upon activation of the energy absorbing device (10). As graphically depicted in FIGS. (2) and (3), the energy absorbing device (10) of the invention maintains, in this case, exactly the same length before and after the tearing of the predetermined folded and sewed portion of the strap (11).

Additional important advantages are achieved by using the energy absorbing device (10) according to the above first preferred embodiment of the invention, such advantages including the smoothening of the tearing of the abutting sewed portions of strap (11) with the linear, parallel to the main surface of the strap (11), displacement of the movable coupling member (30) as it is pulled from the ring (31) and the linear displacement of the point of application of the force in the course of tearing of such abutting sewed portions of strap (11), thereby resulting in the progressive synchronized deformation of the strap being torn and distribution of the force along the entire length of the arm (32) and thus over the entire width of the torn stitches (14) of strap (11) throughout the duration of the tearing process. Thus, use of the independent coupling member (30) that exerts a pulling action onto the energy absorbing device (10) enables incomparably more precise and easier designing of the entire energy absorbing device to be fastened onto the main riser strap (52) of the parachute (50) as the performance thereof becomes accurately predictable.

According to a second embodiment of the invention, as shown in FIGS. (7 and 8), in the two stages, before and after use through tearing of the stitches (14) of the strap, respectively, the aforementioned selected portion of the strap (11) which is folded in a longitudinal direction into half its original length, thereby creating two adjacent half strap portions (11a, 1 1 b), is only a part of the strap (11) and not the entire length thereof as in the aforementioned first embodiment of the invention. As shown in FIG. (7), the strap (11) has its end (1d) fastened to the second coupling member (40) similarly to the previous first embodiment and is thereafter provided with the 3-ring release system (60), the large ring (61) of the latter being bound to the coupling member (30). Then, the strap (11) is being folded to form two adjacent half strap portions (1 1a, 1 1b), which are then sewed with a plurality of transverse stitches (14) for the remaining length of the strap that is preferably wound folded up. An ultimate portion of the strap ends in a folded edge forming an aperture that is being wound around the transverse arm (32) of the coupling member (30) and it is thereby securely and strongly bound by means of stitches to the coupling member (30). In this case, when a force which exceeds a predetermined value is applied on the movable coupling member (30) and the 3-ring release system (60) is unlocked with the release of the large ring (61) which thereafter moves together with the coupling member (30) upwardly, the coupling member (30) through the arm (32) thereof exerts a pulling force and carries out the tearing of the predefined transverse stitches (14), thereby separating the two folded and sewed adjacent strap portions (11a) and (1 1b) of the strap and thus ensuring the absorption of energy released as a result of the force that is suddenly applied by the riser strap (52) of the parachute (50), upon the activation of the energy absorbing device (10). As graphically depicted in FIGS. (7 and 8), the energy absorbing device (10) does not in this case maintain the same length before and after the tearing of the stitches provided in the predetermined folded and sewed portion of the strap (1 1), but after this tearing, it has a length corresponding to the sum of a first fixed portion of length extending from the coupling member (40) up to the beginning of the folded portion and the length of the strap portion (1 1a) and the length of the strap portion (11 b). This increase of the length of the strap renders the energy absorbing device manufactured according to this second embodiment of the invention partially unsuitable for application in security systems because such length increase after the action of the strap is rather excessive in comparison with the energy absorbing devices manufactured according to the first embodiment of the invention wherein the strap maintains the same length prior to and after action thereof.

It is herein noted that the strap (11) may be manufactured from any suitable textile or polyamide, Kevlar/Nylon material, or from any other material of strong composition suitable for sewing with any suitable sewing process or durable thread. The energy absorbing devices (10) of the invention, depending on the nominal value of the energy they are required to absorb in each case which is a function of the weight of the aircraft (70) and of the load it carries, are manufactured by appropriate design of the parameters, such parameters mainly including the number of transverse or lengthwise sewed stitches (14) provided along the folded and sewed length of the strap (11), depending on the strength of the thread (14) with which such stitches are being sewed. The total length of the device (10), which determines the effective length of the linear displacement of the arm (32) along the strap (11) is also, similarly in each of the above embodiments, a parameter determining the nominal value of the energy being absorbed.

It is further noted that the winding of most of the length of the strap in a fold is proposed with a scope of advantageously ensuring a minimal space of positioning the device (10). Stitches (1 1c, 11d) are being provided in order to keep the folded strap in place, such stitches being also torn during cutting off of the sewed and folded length of the strap.

The energy absorbing devices (10) of the invention might be repaired with sewing new stitches after a tearing operation so that they may be ready for a next use.

The activation of the energy absorbing devices (10) of the invention is being performed by the pulling of the retaining pin (65), FIGS. (1, 2, 4), by means of the wire rope (72) of the bowden cable (75) at the option of the pilot, who visually observes the ground proximity of about 7-10 meters and selects activation by pulling the handle (73) so as to attain the maximum contribution of the device in the intended soft landing, FIG. (9). The retaining pin (65) for the rapidly unlocked 3 ring release system (60) is connected to the wire rope (72) of the bowden cable (75) which functions as a device with one end thereof connected to the handle (73) within the cockpit of the aircraft (70), FIG. (9), thereby providing the pulling force required at the other end (74) thereof for the retaining pin (65). The bowden cable (75) comprises a helicoidally twisted outer housing of concentric configuration made of wire and plastic and encases the inner wire (72) made of stainless steel or galvanized steel, or another suitable material. The basic mechanical manufacture of such cables consists of a set of multiple twisted wires and is employed in different combinations for the manufacture of a different version with other cables. More specifically, the present invention concerns a remote system (74) of transmission of force/pulling action resulting from the abruptly acting force as the handle (73), located within the cockpit of said aircraft (70), is slightly pulled. The handle (73) is locked by means of the retaining pin (76) and before the flight said handle (73) is unlocked with the removal of said retaining pin (76).

According to another advantageous preferred embodiment of the invention, aircraft (70) may be equipped with and altimetric photocell (80) capable of infrared detection (81) of ground proximity (82) underneath the aircraft (70), FIGS. (9, 10, 1 1) which measures the distance from the ground and can be adapted to emit a preselected audio signal aimed at alerting the pilot as the aircraft (70) approaches a predetermined height and a distance of approximately 7-8 m from the ground (82), whereby the activation of the energy absorbing device (10) of the invention is performed, or an automatic electromechanical (85) unlocking operation, FIGS. (9,10,11,12,13,14), is performed by the altimetric photocell (80), FIG. (15), and the operation of the energy absorbing device (10) is initiated in all manned aircraft (70), as well as unmanned aerial vehicles (UAV) (86), flying target aerial vehicles (88), airborne cargo on wooden pallets (87) dropped off by means of parachutes (50), parachutists (89), and the Space Command Module (90), FIGS. (11, 12, 13, 14, 16, 17).

The altimeter (80), FIG. (15), with the audio signal emitted thereby during approach to the ground, greatly contributes to warning the pilot when landing in darkness during the night or fog. Such an altimetric photocell (80) capable of infrared detection (81) is shown in FIGS. (9,10,11,12,13,14) preferably attached outside and underneath the cockpit of the aircraft. The altimeter (83) has great potential in alerting the pilot inside the cockpit of the aircraft, FIG. (9), during the approach to the ground at a height of approximately 7-8 m.

It should herein be noted that the description of the invention was made by reference to illustrative examples of application to which it is not limited. Thus, any alteration or modification regarding the described forms, sizes, configurations, materials, and accessories of construction and assembly, techniques applied in the construction and operation of the elements of the invention, as long as they do not constitute a new inventive step and do not contribute to the technical development of the already known, are considered part of the scope and the aims of the present invention, as briefed in the following Claims.

1. Aircraft, UAV, aerial target drone, cargo pallets, descending with a parachute characterized in that it comprises an energy absorbing device being connected to the main riser strap of the parachute adapted for the reduction of the forces exerted during landing thereof wherein the upper end of the energy absorbing device is being mounted with a first coupling member at an upper end thereof connected to the carabiner provided at the end of the main risen strap of the parachute and with a second coupling member at the lower end thereof connected to the carabiner provided at the ends of the respective main riser straps adapted to connect said aircraft, UAV, aerial target drone, cargo pallets, with the parachute, the energy absorbing device comprising a strap of a predetermined length with a selected portion of said strap comprising a strap portion and a strap portion being folded with said strap portion abutting said strap portion, thereby said strap being reduced into half its original predetermined length, said strap portion being sewed onto the abutting said strap portion with a plurality of lengthwise extending stitches, said first coupling member being linked with a 3 ring release system comprising a small ring, a middle ring and a large bottom ring, said 3 ring release system being adapted to maintain said first coupling member under tension, wherein said small ring of the release system of the device is being released by means of the retaining pin of the Bowden cable at a specified time during approach of the ground and said first coupling member is being released together with said large ring of the 3 ring release system thereby causing activation of said energy absorbing device through tearing of said plurality of lengthwise extending stitches that results in the exertion of a force acting in a direction opposite to the weight of said aircraft, UAV, aerial target drone, cargo pallets, and delaying the speed of descent and final impact thereof onto the ground.

2. Aircraft, UAV, aerial target drone, cargo pallets, according to claim 1, characterized in that are equipped underneath with an photocell capable of infrared detection of ground proximity, which measures the distance from the ground and is adapted so that said photocell performs the automatic electromechanical unlocking operation with the connected to the wire rope of the bowden cable which can exert the pulling force required at the other end thereof for the unlocking of the retaining pin.

3. Aircraft, UAV, aerial target drone, cargo pallets, according to claim 1, characterized in that the retaining pin of the rapidly unlocked 3 ring release system is connected to the wire ropeof the bowden cable functioning as a device with one end thereof connected to the handle which, when activated by the pilot of aircraft, can exert the pulling force required at the other end thereof for the unlocking of the retaining pin. The bowden cable encases the internal wire. The handle is locked by means of the retaining pin.

4. Aircraft, UAV, aerial target drone, cargo pallets, according to claim 1, characterized in that said first coupling member is a strong plate with a generally rectangular shape and a width corresponding to the width of the strap, said first coupling member comprising an arm at one end and a suspension D-ring at the other end thereof, said arm being connected to said 3-ring release system and said D-ring being connected to said end carabiner of the main riser strap of the parachute, said first coupling member further comprising an arm extending parallel to the arm and the D-ring, an opening being provided in between said arm and said arm and an opening being provided in between said arm and said D-ring, and said second coupling element is a strong plate comprising a suspension D-ring with a linear arm at other end thereof a well as the linear arm in between them, and an opening in between said linear arm and said D-ring and an opening between said arm and said arm, wherein a lower edge of said strap is being arranged to pass through the opening, folded to form a loop enclosing said linear arm and strongly sewed with stitches along a line thereby securely connecting said strap to said second coupling element.

5. Aircraft, UAV, aerial target drone, cargo pallets, according to claim 1 characterized by the following: said ring of the 3-ring release system is being arranged so as to follow the movement of the first coupling member after having been disconnected from the mutually engaged rings of the 3-ring release system, said middle ring being securely bound to a strip onto said strap, whilst said small ring is securely bound to a strip onto said strap and maintained at a locked condition by means of a retaining pin passing through a short strip with a loop surrounding said small ring, wherein when a slight pulling action is exerted onto the retaining pin, said small ring is released from said loop of the short strip and said large ring is immediately released from said mutually engaged rings, said first coupling member being thereafter moved together with said large ring as it is being attracted by the riser strap of the parachute accordingly activating the energy absorbing device.

6. Aircraft, UAV, aerial target drone, cargo pallets, according to claim 1 characterized in that said selected portion of said strap comprising a strap portion and a strap portion being folded with said strap portion abutting said strap portion is the entire length of said strap, which extends from one edge to the other edge, wherein the strap after attachment of the edge thereof onto said second coupling member passes through the opening of the first coupling element, is thereafter separated into the two strap portions to form an opening, said transverse arm of the first coupling member being enclosed within said opening, said two strap portions being sewed with a plurality of transverse stitches past said opening, wherein when a force exceeding a predetermined value is being exerted onto the first coupling member and said 3-ring release system is unlocked said transverse arm performs tearing of the transverse stitches and effects separation of said abutting strap portions, said tearing of the lengthwise extending stitches thereby providing absorption of the energy produced as a result of an abruptly acting force exerted by said main riser strap of the parachute upon activation of the energy absorbing device and wherein said energy absorbing device retains a precisely same length before use with said strap portions abutting each other and after use with said strap portions having been separated.

7. Aircraft, UAV, aerial target drone, cargo pallets, according to claim 1 characterized in that said selected portion of said strap comprising a strap portion and a strap portion being folded with said strap portion abutting said strap portion is a part of the length of said strap, which has an edge thereof attached onto said second coupling member, said 3-ring release system with said first coupling member being attached onto said strap after attachment thereof onto said second coupling member, said strap being thereafter folded to form said abutting strap portions being sewed with a plurality of lengthwise extending stitches past said 3-ring release system, a terminal portion of said strap being provided with a folded end forming a loop enclosing said transverse arm of said first coupling member and securely and strongly connected therein, wherein when a force exceeding a predetermined value is being exerted onto the first coupling member and said 3-ring release system is unlocked, said transverse arm of said first coupling member performs tearing of the lengthwise extending stitches and effects separation of said abutting strap portions, said tearing of the lengthwise extending stitches thereby providing absorption of the energy produced as a result of an abruptly acting force exerted by said main riser strap of the parachute upon activation of the energy absorbing device.
